(19) United States
(12) Patent Application Publication
(10) Pub. No.: US 2018/0299621 A1
(43) Pub. Date: Oct. 18, 2018

(54) OPTICAL COMBINER AND MANUFACTURING METHOD FOR THE SAME

(71) Applicant: ELECTRONICS AND TELECOMMUNICATIONS RESEARCH INSTITUTE, Daejeon (KR)

(72) Inventors: CHAN IL YEO, Gwangju (KR); Young Soon HEO, Gwangju (KR); Hyun Seo KANG, Gwangju (KR); Sung Chang KIM, Gwangju (KR)

(73) Assignee: ELECTRONICS AND TELECOMMUNICATIONS RESEARCH INSTIT UTE, Daejeon (KR)

(21) Appl. No.: 15/824,576

(22) Filed: Nov. 28, 2017

(30) Foreign Application Priority Data
Apr. 18, 2017 (KR) 10-2017-0050045

(51) Int. Cl. G02B 6/28; H04B 10/079; H01S 3/067; H04B 10/2587; H04J 14/02; G02B 6/42

(52) U.S. Cl. CPC G02B 6/2817; H04B 10/07953; G02B 6/4203; H04B 10/2587; H04J 14/0278; H01S 3/06704

(57) ABSTRACT

The present invention relates to an optical combiner and a manufacturing method thereof, and a plurality of light source units emitting an optical signal. A reflection unit having a plurality of reflection surfaces disposed on a path of the optical signal and reflecting the optical signal so as to face toward an optical fiber, and an optical fiber holder fixing the optical fiber at a position where the optical signal reflected by the plurality of reflection surfaces is focused is included. An optical combiner and a manufacturing method thereof in which an optical fiber holder includes a plurality of division members that are radially disposed with respect to a center part of the reflection unit are disclosed.

### CROSS-REFERENCE TO RELATED APPLICATION

This application claims priority to and the benefit of Korean Patent Application No. 10-2017-0050045 filed in the Korean Intellectual Property Office on Apr. 18, 2017, the entire contents of which are incorporated herein by reference.

### BACKGROUND OF THE INVENTION

### (a) Field of the Invention

The present invention relates to an optical combiner and a manufacturing method thereof. More particularly, the present invention relates to an optical combiner focusing an optical signal emitted from a light source to one optical fiber, and a manufacturing method thereof.

### (b) Description of the Related Art

As a necessity for large capacity information transmission increases in development of an information society, a wavelength division multiplexing (WDM) method may be used in an optical transmission method.

The wavelength division multiplexing method is a method of combining optical signals emitted from several channels having different wavelengths and transmitting them through one optical fiber, and large capacity information transmission is possible through usage of an optical communication network of a conventional installation without additionally installing an optical communication network by transmitting and grouping the multi-wavelength optical signals as one.

In the case of the wavelength division multiplexing method, an optical combiner for grouping optical signals of multiple channels to be coupled in one optical fiber may be used, and as the optical combiner increasing optical coupling efficiency by minimizing an optical signal loss is designed and manufactured and a packing process with the optical fiber may be easily and precisely executed, increasing production efficiency and reducing production cost are considered as very important tasks in the optical combiner for the optical signal transmission.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an optical combiner with increased optical coupling efficiency while minimizing optical signal loss and increasing production efficiency through simple and precise packing in the optical combiner used in the optical transmission method.

An optical combiner according to an exemplary embodiment of the present invention includes: a plurality of light source units emitting an optical signal; a reflection unit disposed on a path of the optical signal and prepared with a plurality of reflection surfaces reflecting the optical signal so as to face toward an optical fiber; and an optical fiber holder fixing the optical fiber at a position where the optical signal reflected by the plurality of reflection surfaces is focused, wherein the optical fiber holder includes a plurality of division members radially disposed with respect to a center part of the reflection unit.

The plurality of light source units may be radially disposed with respect to the reflection unit.

The plurality of reflection surfaces may correspond to the plurality of light source units and at least parts thereof may be radially disposed to be mutually separated.

The reflection surface may be provided as an inclined plate to reflect the optical signal emitted from the light source unit to an upper side of the center part of the reflection unit, and the optical fiber holder may fix the optical fiber at the upper side of the center part of the reflection unit.

The reflection surface may be prepared so that a horizontal distance of one end toward the light source unit and the other end toward the center part of the reflection unit may be longer than a mutual vertical height.

The plurality of reflection surfaces may have at least parts separated from each other to be positioned between the center part of the reflection unit and the plurality of light source units, and the plurality of division members may be respectively positioned at each separation space between the plurality of reflection surfaces.

The plurality of division members configuring the optical fiber holder may be disposed to enclose a circumference of the reflection unit.

The plurality of division members may be shaped such that a part toward the center part of the reflection unit may have a step at a top thereof, such that a seating part to which the optical fiber is seated may be formed.

The light source unit may emit the optical signal to separated spaces between the plurality of division members.

A substrate supporting the optical fiber holder, the light source unit, and the reflection unit may be further included.

A focusing lens disposed on a path of the optical signal between the reflection unit and the light source unit and a lens holder to which the focusing lens is seated may be further included, wherein the lens holder may be supported to the substrate along with the optical fiber holder, the light source unit, and the reflection unit.

A power unit and a driver IC for the light source unit may be mounted on the substrate.

The optical fiber holder or the lens holder may include a fixing member that is hardened to enclose the optical fiber or the focusing lens at a part where the optical fiber or the focusing lens is fixed.

A manufacturing method of an optical combiner according to an exemplary embodiment of the present invention includes: press-molding an optical fiber holder fixing a base and an optical fiber configuring a reflection unit; preparing a reflection surface at the base and mounting a light source unit emitting an optical signal to face the reflection surface; and seating and fixing the optical fiber to the optical fiber holder.

In the molding, a deformation layer coated on at least one surface of the substrate may be press-molded to mold the base and the optical fiber holder to the substrate.

In the mounting, the reflection surface may be formed at a part of the deformation layer, or a metal coating part to which the light source unit may be mounted may be provided, and the light source unit is mounted to the metal coating part.

A power unit and a driver IC of the light source unit may be further mounted to the substrate in the mounting.

A lens holder to which the focusing lens is seated may be press-molded along with the base and the optical fiber holder in the molding, and the focusing lens may be mounted to the lens holder in the mounting.

The manufacturing method may further include providing and hardening a fixing member to fix the optical fiber or the lens holder at a part where the optical fiber or the focusing lens is seated and fixed in the optical fiber holder or the lens holder, after the fixing.

As above-described, according to an exemplary embodiment of the present invention, the optical fiber holder to fix the optical fiber is provided as the division member such that freedom for arrangement of the optical fiber holder may be improved, and a volume occupied by the optical fiber holder is effectively reduced such that it is possible to improve spatial utility and to be accuracy packaged.

Also, in an exemplary embodiment of the present invention, the division member of the optical fiber holder is radially disposed along with the reflection surface with respect to the center part of the reflection unit, the accuracy in the optical signal focus may be improved, and simultaneously structural stability may be effectively improved.

In addition, an exemplary embodiment of the present invention may package optical combiner components together on the single substrate such that the easy and accurate packaging may be enabled and accuracy of the process may be improved, thereby optical coupling efficiency may be improved and production efficiency may also be effectively improved.

### BRIEF DESCRIPTION OF THE DRAWINGS

FIG. 1 is a view showing an optical combiner according to an exemplary embodiment of the present invention.

FIG. 2 is a view showing an optical combiner in which an optical fiber is fixed according to an exemplary embodiment of the present invention.

FIG. 3 is a cross-sectional view of an optical combiner according to an exemplary embodiment of the present invention.

FIGS. 4 and 5 are graphs showing a fixing height change of an optical fiber depending on a horizontal distance change between ends of a reflection surface in an optical combiner according to an exemplary embodiment of the present invention.

FIGS. 6 and 7 are graphs showing a permissible range change of a height of an optical fiber depending on a horizontal distance change between ends of a reflection surface for a single mode optical fiber and a multi-mode optical fiber in an optical combiner according to an exemplary embodiment of the present invention.

FIG. 8 is a view showing a shape of a division member of an optical fiber holder that is positioned between reflection surfaces according to an exemplary embodiment of the present invention.

FIG. 9 is a view showing a shape of a division member of an optical fiber holder that is disposed to enclose a periphery of a reflection unit according to an exemplary embodiment of the present invention.

FIG. 10 is a view showing various shapes of a reflection unit in an optical combiner according to an exemplary embodiment of the present invention.

FIG. 11 is a flowchart showing a manufacturing method of an optical combiner according to an exemplary embodiment of the present invention.

FIGS. 12 to 14 are views showing a manufacturing process of an optical combiner according to an exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In this specification, redundant description of the same constituent elements is omitted.

Also, in this specification, it is to be understood that when one component is referred to as being “connected” or “coupled” to another component, it may be connected or coupled directly to the other component or may be connected or coupled to the other component with a further component intervening therebetween. On the other hand, in this specification, it is to be understood that when one component is referred to as being “connected or coupled directly” to another component, it may be connected or coupled to the other component without a further component intervening therebetween.

It is also to be understood that the terminology used herein is only for the purpose of describing particular embodiments, and is not intended to be limiting of the invention.

Singular forms are to include plural forms unless the context clearly indicates otherwise.

It will be further understood that the term “comprises” or “have” used in the present specification specify the presence of stated features, numerals, steps, operations, components, parts, or a combination thereof, but does not preclude the presence or addition of one or more other features, numerals, steps, operations, components, parts, or a combination thereof.

Also, as used herein, the term “and/or” includes any of a plurality of combinations of items or any of a plurality of listed items. In this specification, “A or B” may include “A”, “B”, or “A and B”.

Now, preferable exemplary embodiments of the present invention will be described with reference to accompanying drawings.

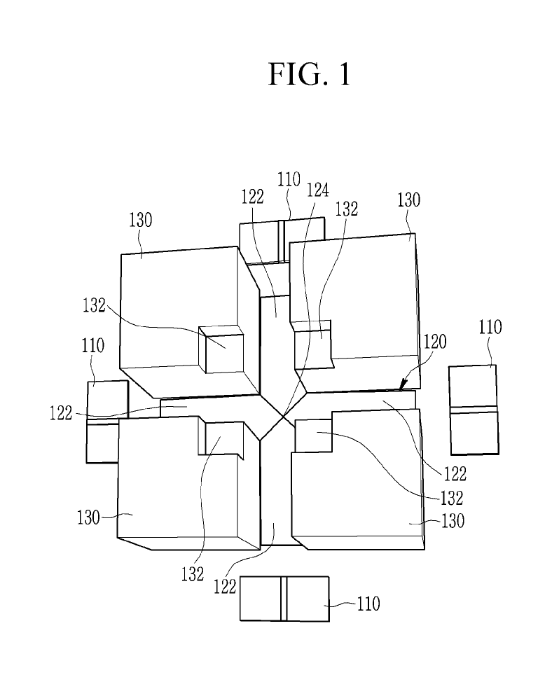

As shown in FIGS. 1 to 3, the optical combiner according to the present invention includes: a plurality of light source units 110 provided to emit an optical signal; a reflection unit 120 in which a plurality of reflection surfaces 122 are disposed on a path of the optical signal and that reflects the optical signal toward an optical fiber 140; and an optical fiber holder 130 fixing the optical fiber 140 at a position where the optical signal reflected by the plurality of reflection surfaces 122 is focused, wherein the optical fiber holder 130 includes a plurality of division members radially disposed based on a center part 124 of the reflection unit 120.

In detail, the light source unit 110 is provided in plural to output an optical signal. The plurality of light source units 110 may emit optical signals having different wavelengths from each other. As the optical combiner of the present invention has the plurality of light source units 110, the optical combiner may be used in a wavelength division multiplexing method of an optical transmission method.

The light source unit 110 may be formed of a light source body outputting the optical signal and a structure to which the light source body is seated. A fixed height of the optical fiber 140 to which the optical signal is focused may be changed depending on a height of the light source body, and this is described in detail later.

Preferably, the plurality of light source units 110 may have the same height of the light source body as each other, and may emit the optical signal to be parallel to a substrate 150 to which the light source unit 110 is coupled as described below. In the following description, the height of the light source body is expressed as the height of the light source unit 110 for convenience of explanation.

The plurality of light source units 110 may be arranged in various shapes. Preferably, the plurality of light source units 110 are radially arranged such that it is advantageous in design error reduction and structural stability may be improved. More preferably, the plurality of light source units 110 may be disposed so as to have the same distance from a radial center.

Each light source unit 110 may emit an optical signal of a different wavelength, and in this case, the plurality of optical signals are focused to one optical fiber 140 through the reflection unit 120, thereby realizing the wavelength division multiplexing method.

FIGS. 1 to 3 show the exemplary embodiment in which the plurality of light source units 110 emitting the optical signal are provided to be radially disposed.

On the other hand, the reflection unit 120 is disposed on a path of the optical signal such that a plurality of reflection surfaces 122 reflecting the optical signal toward the optical fiber 140 are provided.

The present invention provides the plurality of light source units 110 to easily realize the wavelength division multiplexing method, and accordingly the reflection surfaces 122 of the reflection unit 120 may be provided in plural to correspond to a number of the light source units 110. The reflection unit 120 may consist of the reflection surface 122 reflecting and a base supporting the reflection surface 122.

The reflection units 120 are provided so that the plurality of reflection surfaces 122 are respectively disposed on the path of the optical signal emitted from the light source unit 110. Each of the reflection surfaces 122 is provided as a division member to be disposed on each optical signal path of the light source unit 110, and the reflection unit 120 may be formed as a single unit, but a plurality of reflection surfaces 122 may be provided so as to face the light source unit 110.

Also, the shape of the reflection unit 120 may be various, and the plurality of reflection surfaces 122 may be provided to have an arrangement shape corresponding to an arrangement of the light source unit 110. For example, according to the preferable exemplary embodiment of the present invention, the light source units 110 are radially disposed, so the reflection surfaces 122 may also be disposed to be radial.

On the other hand, in the exemplary embodiment of the present invention shown in FIGS. 1 to 3, the reflection surface 122 is provided in the form of a plate having a length, and an end portion toward the light source unit 110 with respect to the radial direction of the radius may be provided to have a lower height than that of the opposite end portion in an inclined plate shape.

That is, in the various exemplary embodiments of the present invention, in the exemplary embodiment of the present invention provided in FIGS. 1 to 3, the reflection surface 122 is provided to reflect the optical signal so as to face an upper side of the reflection unit 120. However, the reflection direction of the optical signal is not limited to the upper side of the reflection unit 120 and may be variously set if necessary.

Although the reflection unit 120 may consist of a base and a reflection surface 122 as described above, the reflection surface 122 and the base may be prepared as a single body or may be constructed as separated bodies.

When the reflection surface 122 and the base are prepared as the single body, one surface forming the base may be used as the reflection surface 122. When the reflection surface 122 and the base are prepared as separated bodies, it may be formed by coating a metal material having high reflectance and excellent conductivity on the base in order to improve process efficiency and accuracy.

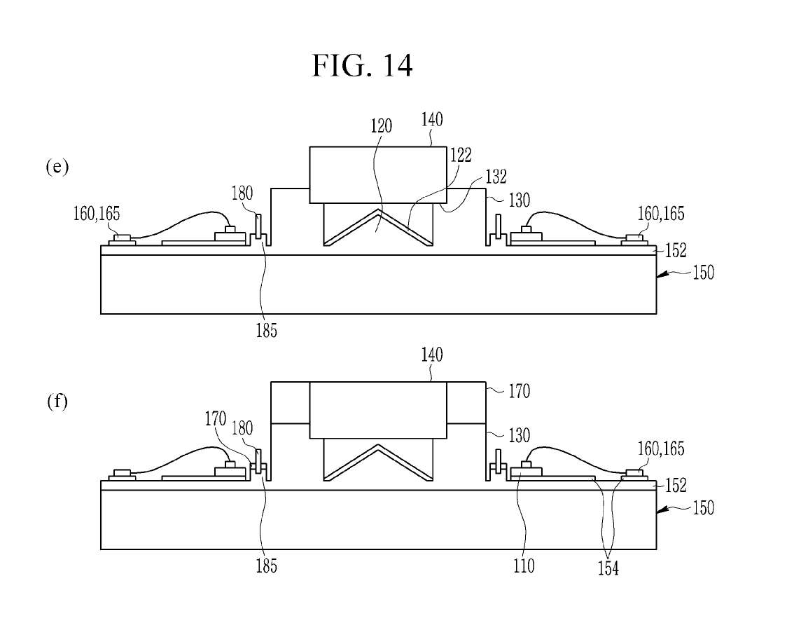

As described in the following, as shown in FIG. 14, there can be a plurality of parts coated with a metal material in an exemplary embodiment of the present invention, which can be defined as a metal coating part 154, and the metal coating part 154 may be provided as a part on which the reflection surface 122 is formed or the light source unit 110 is mounted in the surface of the base.

On the other hand, the optical fiber holder 130 fixes the optical fiber 140 at a position where the optical signal reflected by the plurality of reflection surfaces 122 is focused, and the optical fiber holder 130 includes a plurality of division members radially disposed with respect to the center part 124 of the reflection unit 120.

In the present invention, the plurality of optical signals emitted from the plurality of light source units 110 are respectively focused to the optical fiber 140 by the reflection surface 122. In an exemplary embodiment of the present invention, the optical fiber holder 130 is provided to fix the optical fiber 140, and the optical fiber holder 130 fixes the optical fiber 140 so as to position a core of the optical fiber 140 at a position where the plurality of optical signals reflected by the reflection surface 122 are focused.

In the present invention, the optical fiber holder 130 may be provided with various shapes and structures, and particularly, in an exemplary embodiment of the present invention, the optical fiber holder 130 consists of a plurality of division members. It is preferable that the division members may be radially disposed with respect to the center part 124 of the reflection unit 120 and that a plurality of division members may be provided together to support and fix the optical fiber 140.

In an exemplary embodiment of the present invention, the reflection surface 122 may be provided with an inclined plate shape, and accordingly, the optical signal may be focused to the upper side of the reflection unit 120. However, it is not limited thereto, and the optical signal may be focused to a lower side or a lateral side of the reflection unit 120 depending on the shape of the reflection surface 122.

The optical fiber holder 130 is radially disposed with respect to the center part 124 of the reflection unit 120, and may be provided with a shape having a height so as to fix the optical fiber 140 at the position where the optical signal is focused. Preferably, the optical fiber holder 130 may be provided on the same substrate 150 as the light source unit 110 and the reflection unit 120.

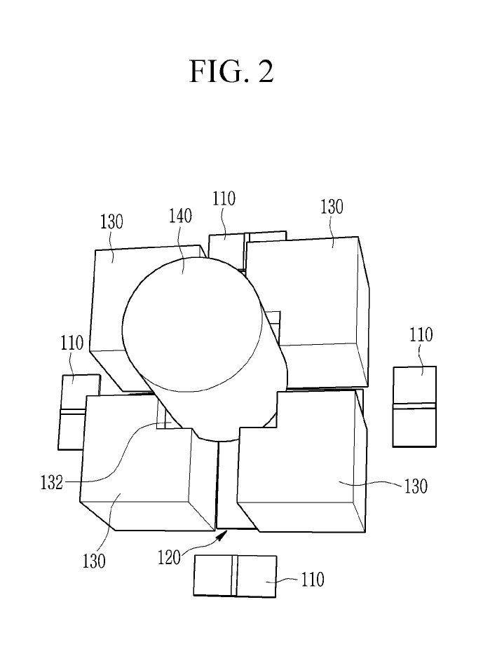

The optical fiber holder 130 may have various cross-sectional shapes. Preferably, the shape is a circle or a polygon that is radially separated with respect to the center, thereby forming the cross-sectional shape of each division member. FIG. 1 and FIG. 2 show an exemplary embodiment in which each division member has a cross-sectional shape of a square.

The cross-sectional shape of the division member may particularly correspond to the number of light source units 110 and reflection surfaces 122. In an exemplary embodiment of the present invention shown in FIGS. 1 and 2, for explanation of the present invention, four light source units 110 and reflection surfaces 122 are respectively made so that the division member of the optical fiber holder 130 is shown to have the square cross-section. However, it is not limited thereto, and the cross-section of the division member may have various shapes as well as the square cross-section.

In the case of the present invention, the optical fiber holder 130 configured of the plurality of division members fixes the optical fiber 140, thereby largely reducing a volume occupied by the optical fiber holder 130. Preferably, the optical fiber holder 130 may be provided together on the substrate 150 on which the light source unit 110 and the reflection unit 120 are provided, and in this case, as the optical fiber holder 130 consists of the division member, the spatial freedom of the arrangement of the optical fiber holder 130 is greatly improved, the volume occupied by the optical fiber holder 130 can be greatly reduced, and the spatial utility is greatly improved.

Also, design precision is very important in the optical combiner focusing the optical signal, and in this case, the optical fiber holder 130 of the present invention largely improves the structural stability fixing the optical fiber 140 as the division members thereof are radially disposed with respect to the center of the reflection unit 120.

FIG. 1 and FIG. 2 show an exemplary embodiment in which four light source units 110, four reflection surfaces 122 of the reflection unit 120, and four division members of the optical fiber holder 130 are respectively provided. In this case, the division member of the optical fiber holder 130 is provided in the shape of a square pillar and is disposed so as to form the radial shape with respect to the center part 124 of the reflection unit 120, and this is also the same as the light source unit 110 and the reflection surface 122.

In accordance with the structure as described above, an efficient structure in constructing a plurality of light source units 110 may be obtained and effective design is possible in increasing the number of the light source units 110.

For example, to increase the number of the light source units by two times, in the exemplary embodiment of FIG. 1 and FIG. 2, the numbers of the light source units 110, the reflection surfaces 122, and the division member that are radially disposed are only increased while maintaining the structural features such as the design characteristics, so it is very advantageous in design.

Also, as shown in FIGS. 1 and 2, in the preferable exemplary embodiment of the present invention, the light source unit 110, the reflection unit 120, and the optical fiber holder 130 may be provided on approximately the same plane or on the same substrate 150. A semiconductor fabrication process and a packaging process that is utilized during semiconductor fabrication may be used to seat the above-described components on the single substrate.

Resultantly, although an exemplary embodiment of the present invention provides the optical fiber holder 130 on the same substrate 150, since the optical fiber holder 130 of the present invention consists of the plurality of division members, it is very advantageous in reducing the volume of the entire optical combiner from the spatial aspect and it is especially effective in reducing the size of the packaging.

Furthermore, because the division members of the optical fiber holder 130 are also radially disposed to precisely fix the optical fiber 140, preferably the optical fiber 140 located at the center side is supported and fixed together therewith, so precise and stable fixation of the optical fiber 140 becomes possible.

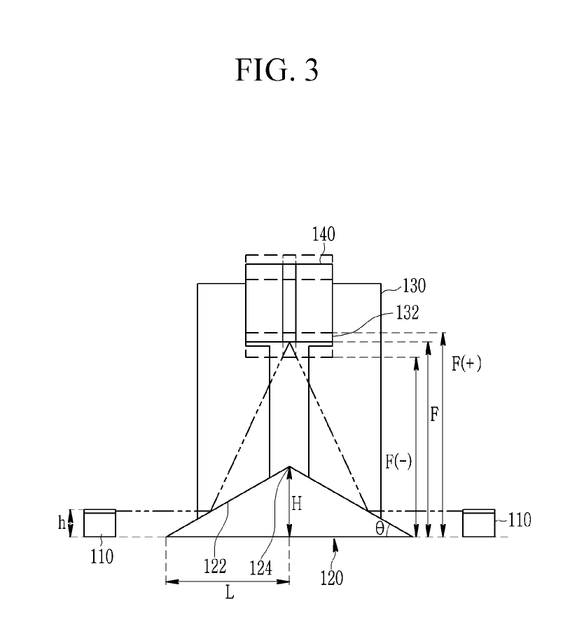

On the other hand, FIG. 3 is a cross-sectional view of the optical combiner according to an exemplary embodiment of the present invention from the side. Here, a definition of the side of the optical combiner may be variously determined as necessary, and preferably, it can be understood that it means one side viewed in a parallel direction with respect to the surface or the substrate 150 on which the light source unit 110, the reflection unit 120, and the optical fiber holder 130 are mounted.

Referring to FIG. 3, the design characteristics of the optical combiner according to the present invention are shown. FIG. 3 shows a preferable exemplary embodiment among the various exemplary embodiments according to the present invention, wherein a height of the light source body emitting the optical signal in the light source unit 110 is indicated by h, and a height of the center part 124 of the reflection unit 120 or the height of the end of the center side of the reflection surface 122 is indicated by H.

Here, the definition of H may be understood by a vertical height difference from the substrate 150 of both ends of the reflection surface 122. Also, in the present invention, a standard of the height that may be defined on a base surface or the substrate 150 corresponds to the position of the edge viewing the light source unit 110 on the reflection surface 122, and this may be variously set as necessary.

In FIG. 3, a horizontal distance between both ends of the reflection surface 122 is indicated by L, and an angle of the reflection surface 122 with the base surface or the substrate 150 is indicated by θ. The height F at which the optical fiber 140 is positioned may be resultantly determined by the setting of θ. In FIG. 3, a minimum height F(−) and a maximum height F(+) of F where the optical fiber 140 capable of focusing the optical signal on a core is placed are displayed.

The design characteristic of the optical combiner according to an exemplary embodiment of the present invention is described with reference to FIG. 3.

First, h, H, and F are defined based on the height from the base surface or the substrate 150, and the setting of the base surface or the substrate 150 as described above may be the height of the end positioned at the lower side from the reflection surface 122.

In the reflection unit 120, the L and the H are related with the value θ. For example, as the H increases, the value θ increases. The focus position of the optical signal reflected by the reflection surface 122 may be resultantly determined by the relation of the h, and the θ and the L, and the height of the focus position of the optical signal corresponds to the F as the height of the optical fiber 140 as a result.

That is, in the present invention, the height F to which the optical fiber 140 is fixed corresponds to a determination value using the values h, L, and H as variables. In the present invention, the optical fiber holder 130 includes a seating part 132 on which the optical fiber 140 is seated as described below, and in this case, the height F of the optical fiber 140 by the seating part 132 is determined from F(−) to F(+) depending on the design of the light source unit 110 and the reflection unit 120, and this corresponds to the design characteristic of the present invention to improve the optical focus efficiency. Also, preferably, it is effective to focus on a plurality of optical signals of which the value of θ has a value smaller than 45 degrees.

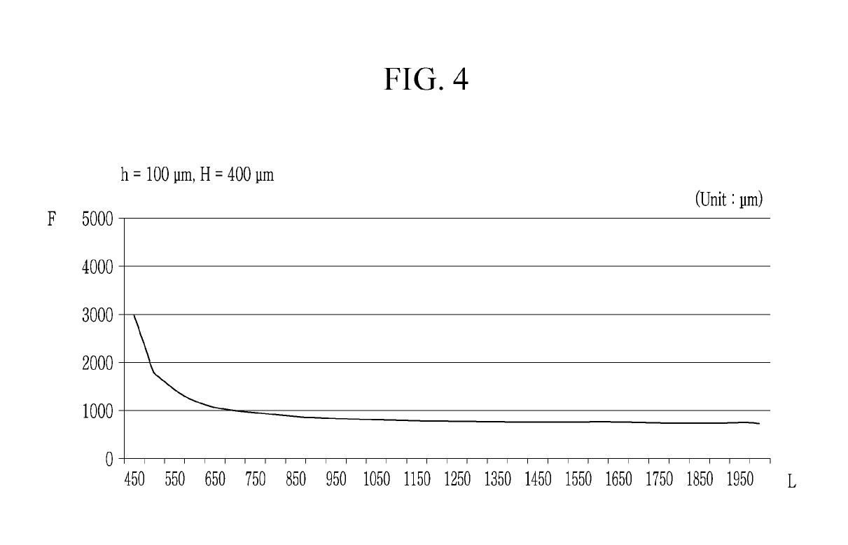

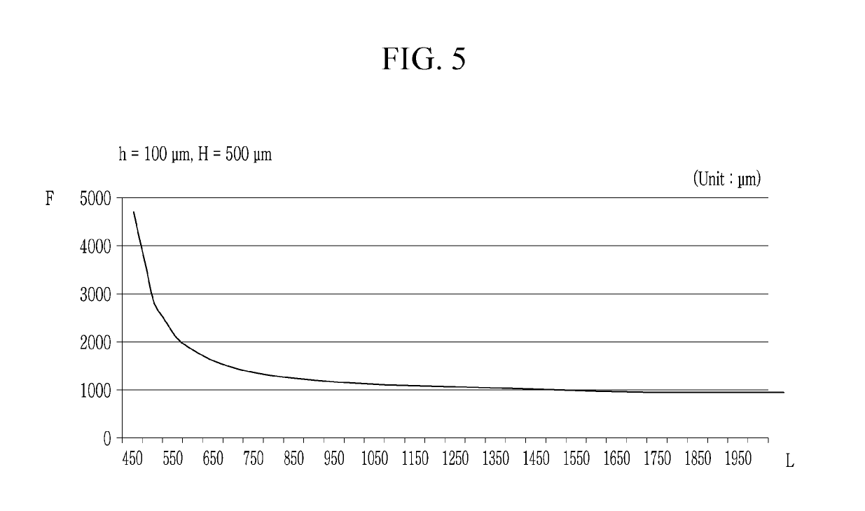

On the other hand, FIG. 4 and FIG. 5 show the change of the value F depending on the change of the value L on certain values h and H as a graph. Referring to FIG. 4 and FIG. 5, it may be confirmed that the value F decreases as the value L increases, and this means that the focus position height of the optical signal resultantly reflected by the reflection surface 122 gradually decreases due to the decrease of the value θ because the value θ decreases as the value L increases with the fixed value H.

FIG. 4 and FIG. 5 show resulting values for the different values H from each other, wherein the value H of FIG. 5 is predetermined to be larger than the value H of FIG. 4, and for the description of the present invention, FIG. 4 shows the value H that is set to 400 um and FIG. 5 show the resulting value in a given situation in which the value H is set to 500 um.

It may be confirmed that the value F in FIG. 5 is higher the value F in FIG. 4 with the same value L, and this may be because the value θ from FIG. 5 is set to be larger than the value θ of FIG. 4 as the value H is set to a large value.

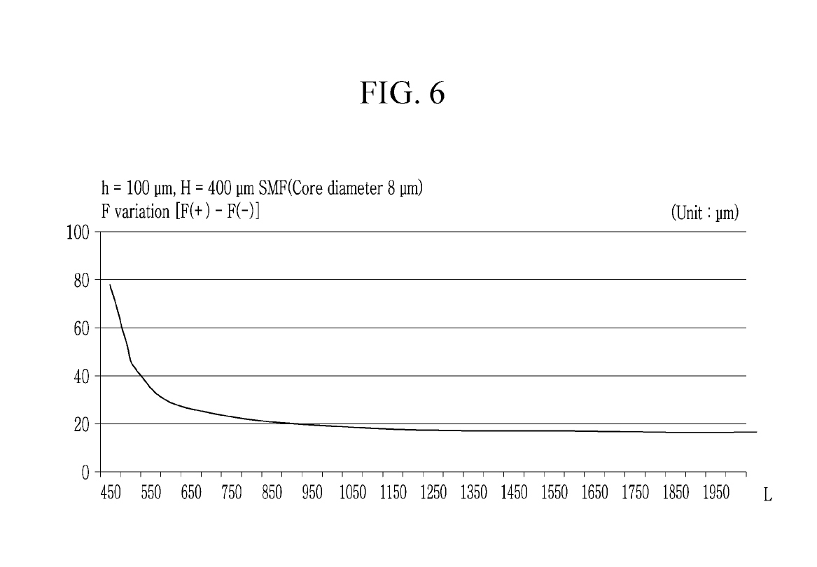

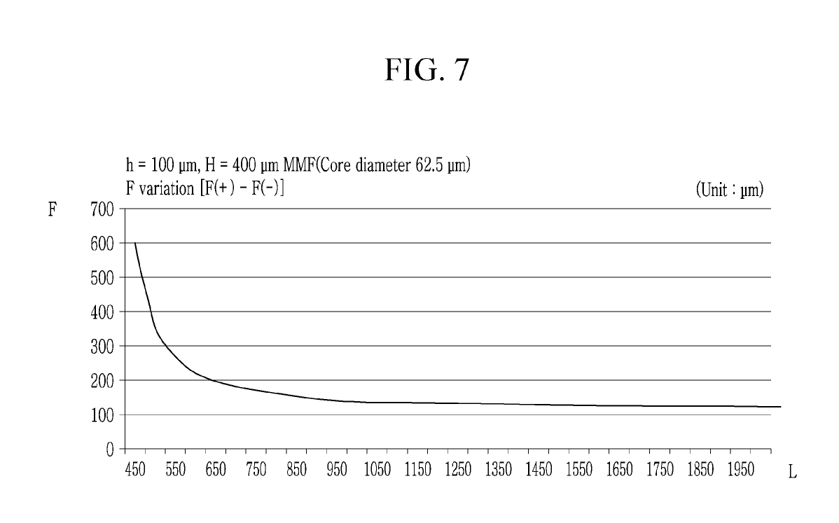

On the other hand, FIG. 6 shows a permissible range change of the value F depending on the change of the value L in a case of using a single mode optical fiber, and FIG. 7 shows a permissible range change of the value F depending on the change of the value L in a case of using a multi-mode optical fiber. The permissible range of the value F means a difference value of the value F(+) and the value F(−) in the definition of the design of the present invention.

Comparing the graphs of FIG. 6 and FIG. 7, it may be confirmed that the permissible range of the value F of the multi-mode optical fiber 140 having the relatively wide core diameter is larger than the permissible range of the value F of the single mode optical fiber 140.

In the optical combiner structure, a permissible error range for the manufacturing and the packaging increases as the permissible range of the value F is larger. If necessary, to increase the coupling efficiency between the optical signal and the optical fiber 140, a lens may be additionally provided between the light source unit 110 and the reflection surface 122.

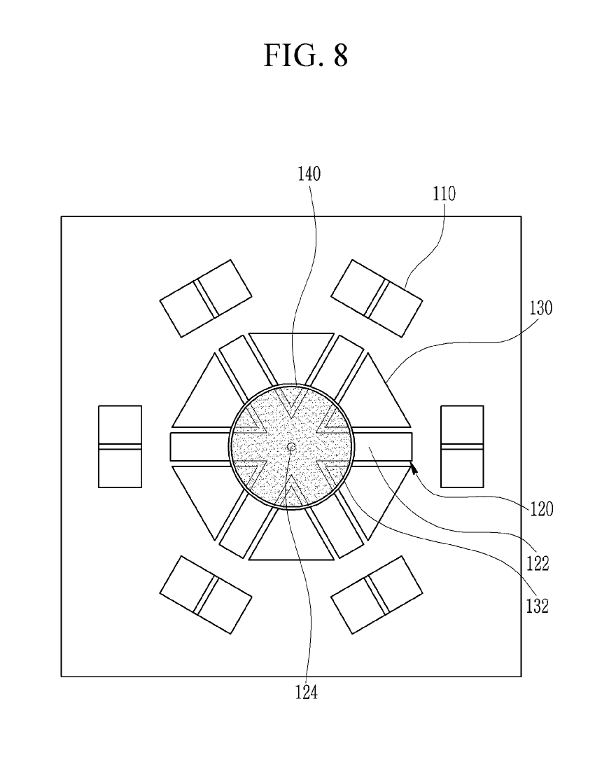

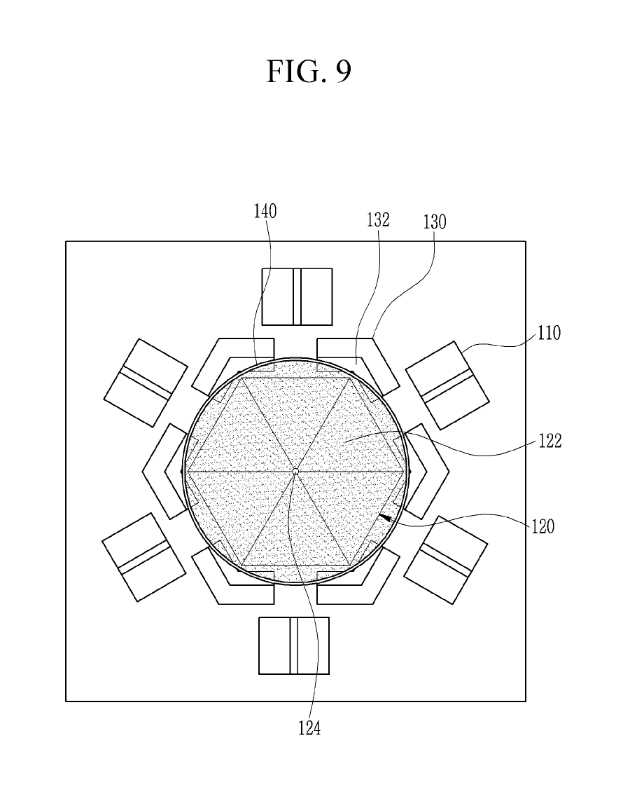

On the other hand, as shown in FIG. 1, FIG. 2, FIG. 8, and FIG. 9, in the optical combiner according to an exemplary embodiment of the present invention, the plurality of light source units 110 may be radially disposed based on the reflection unit 120.

As described above, in the preferable exemplary embodiment of the present invention, the plurality of light source units 110 may be radially disposed based on the reflection unit 120 (in detail, the center part 124 of the reflection unit 120), and this is an advantageous structure for improving optical integration efficiency.

That is, each light source unit 110 has mutual symmetry and form the radial shape based on the center part 124 of the reflection unit 120, however, when optimum design is made between any of the light source units 110 and the optical fibers 140, the design value for the plurality of light source units 110 may also be equally applied, thereby being advantageous.

The design advantage of the present invention as described above is more effective as the number of light sources 110 is increased. When the number of light source units 110 is increased, the optimal design for focusing on a plurality of optical signals while including the added light source unit 110 should be derived, and in this case, in the structure in which the light source units 110 form the radial shape according to an exemplary embodiment of the present invention, if only the mutual separation distance between the light source units 110 is adjusted, because the design change may be done to increase the number of light source units 110, it is advantageous to effectively increase the number of light source units 110 while maximizing the optical focus efficiency.

In FIG. 1 and FIG. 2, the optical combiner structure providing four light source units 110 as an exemplary embodiment of the present invention is shown, and FIG. 8 and FIG. 9 show the structure providing six light source units 110 as another exemplary embodiment of the present invention.

Comparing FIG. 8 and FIG. 9 with FIG. 1 and FIG. 2, because the mutual distance between the light source units 110 of FIG. 8 and FIG. 9 only decreases, it is not necessary to change the other design characteristics, thereby providing an example of effectively increasing the number of the light source units 110.

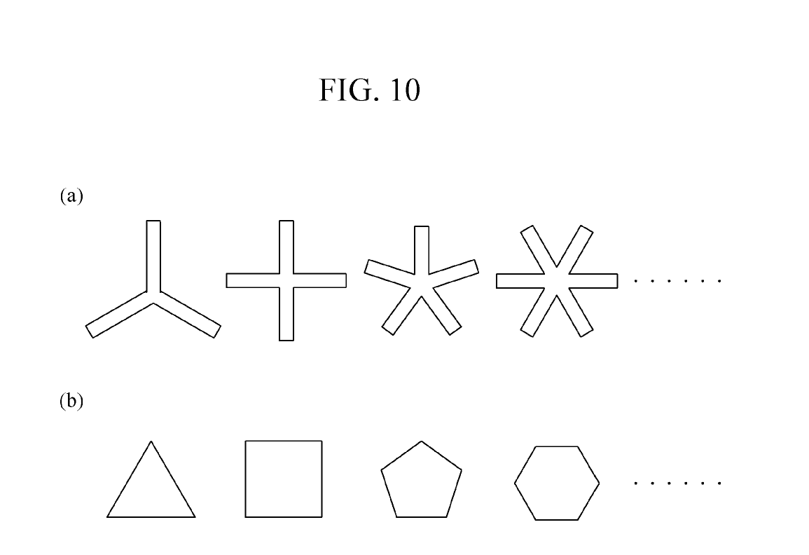

On the other hand, like FIG. 1, FIG. 2, FIG. 8, and FIG. 10, in the optical combiner according to an exemplary embodiment of the present invention, the plurality of reflection surfaces 122 corresponds to the plurality of light source units 110, and at least some thereof are mutually separated to be radially disposed.

As described above, in the present invention, various exemplary embodiments for the shape of the reflection unit 120 are possible. Particularly, in the preferred embodiment of the present invention, the reflection surfaces 122 of the reflection unit 120 can be radially disposed so that at least some are spaced apart from each other.

More preferably, a plurality of reflection surfaces 122 are provided integrally with each other at the ends facing the center part 124 of the reflection unit 120, but the shape is provided such that the mutual separation distance increases toward the end towards the light source unit 110.

The fact that the reflection surface 122 has a mutual separation distance means that a separation space is formed, and accordingly the volume occupied by the reflection unit 120 can be reduced and it can be advantageous for accurate packaging of the optical combiner. Also, as the area of the reflection surface 122 is reduced, there is an advantage of simplifying the manufacturing process and reducing the manufacturing cost.

As an exemplary embodiment of the present invention, in FIG. 1, FIG. 2, and FIG. 8, the plurality of reflection surfaces 122 are integrally provided in the center part 124 of the reflection unit 120, but the shape in which the separation distance increases toward the light source unit 110 is provided.

Particularly, the structure of the reflection unit 120 is advantageous to increase the number of light source units 110 so as to increase the number of channels of the optical signal by only increasing a number of reflection surfaces 122 extending from the center part 124 of the reflection unit 120.

However, the structure of the reflection unit 120 shown in FIG. 1, FIG. 2, and FIG. 8 corresponds to an exemplary embodiment of the present invention, and the shape of the reflection unit 120 of the present invention is not limited thereto and numerous variations are possible. FIG. 10 (a) shows various exemplary embodiments of the shape of the reflection unit 120 having the above characteristics.

On the other hand, as shown in FIG. 1 to FIG. 3, in the optical combiner according to an exemplary embodiment of the present invention, the reflection surface 122 is provided with the inclined plate shape so as to reflect the optical signal emitted from the light source unit 110 to the upper side of the center part 124 of the reflection unit 120, and the optical fiber holder 130 may fix the optical fiber 140 to the upper side of the center part 124 of the reflection unit 120.

In the preferred exemplary embodiment of the present invention, the light source unit 110, the reflection unit 120, and the optical fiber holder 130 may be provided together on the same substrate 150, and more preferably, may be provided so that the plurality of optical signals emitted from the light source unit 110 by the reflection unit 120 have the focus position at the upper side of the reflection unit 120.

FIG. 3 shows this exemplary embodiment. In FIG. 3, the reflection unit 120 reflects the optical signal emitted approximately parallel to the base surface or the substrate 150 from the light source unit 110 to the upper side of the reflection unit 120. In this case, preferably, the plurality of optical signals reflected by the reflection unit 120 may be reflected so as to be mutually focused at one position of the upper side of the reflection unit 120, and this exemplary embodiment is shown in FIG. 3.

Preferably, the optical fiber 140 is fixed so that the plurality of optical signals are focused to a position of the lower surface of the optical fiber 140, so the plurality of optical signals may be focused to the core of the optical fiber 140 while minimizing a loss rate.

FIG. 1 shows the optical fiber holder 130 in the optical combiner before the optical fiber 140 is seated and fixed thereto according to an exemplary embodiment of the present invention, and FIG. 2 shows the shape of the optical fiber 140 that is seated and fixed to the optical fiber holder 130 in the optical combiner of FIG. 1.

Referring to FIG. 3, it may be confirmed that the lower surface of the optical fiber 140 as the height F of the optical fiber 140 fixed by the optical fiber holder 130 is positioned where the plurality of optical signals are focused.

In addition, as shown in FIG. 3, in the optical combiner according to an exemplary embodiment of the present invention, the reflection surface 122 may be provided so that a horizontal distance of one end toward the light source unit 110 and the other end toward the center part 124 of the reflection unit 120 is longer than a mutual vertical height.

In detail, in an exemplary embodiment of the present invention, the reflection surface 122 may be provided with the plate shape having both ends and may be configured with one end toward the light source unit 110 and the other end toward the center part 124 of the reflection unit 120. The horizontal distance of the one end and the other end is indicated by L in FIG. 3, and the vertical height of the one end and the other end is indicated by H in FIG. 3.

That is, the value L is set to be larger than the value H in an exemplary embodiment of the present invention, and this may be understood as meaning that the value θ is less than or equal to 45 degrees.

As the preferred exemplary embodiment of the present invention, if the value θ is more than 45 degrees, the plurality of optical signals do not have the point of being mutually focused after being reflected by the reflection surface 122 and may have mutually parallel paths or the distance from each other far away from the reflection unit 120.

As described above, in order to take a plurality of optical signals which do not have the point of being focused, the diameter of the optical fiber 140 must be larger than the diameter of the at least reflection unit 120 regardless of the height F of the optical fiber 140.

This is disadvantageous in carrying out the compact packaging of the optical combiner according to an exemplary embodiment of the present invention. Furthermore, this may be further disadvantageous when considering the increase of the area occupied by the optical fiber holder 130 fixing the optical fiber 140.

Finally, since the value L of the reflection surface 122 is set to be larger than the value H and the value θ is formed to be 45 degrees or less in the exemplary embodiment of the present invention, as it is possible to prevent the unnecessary increase in the diameter of the optical fiber 140 as well as to make the effective focus of the optical signal and also to effectively reduce the volume occupied by the optical fiber holder 130, the light focus efficiency may be improved and the compact packaging with high accuracy may be implemented.

On the other hand, as shown in FIG. 1, FIG. 2, and FIG. 8, in the optical combiner according to an exemplary embodiment of the present invention, the plurality of reflection surfaces 122 may be spaced apart from each other at least partially so as to be located between the center part 124 of the reflection unit 120 and the plurality of light source units 110, and the plurality of division members may be respectively positioned at the separation space between the plurality of reflection surfaces 122.

As described above, the present embodiment of the present invention may be prepared so that the reflection surfaces 122 of the reflection unit 120 are spaced apart at least partially. According to the preferred exemplary embodiment of the present invention, the division members of the optical fiber holder 130 are respectively positioned in the separation space between the reflection surfaces 122, thereby improving the spatial utility.

In FIG. 1, FIG. 2, and FIG. 8, according to an exemplary embodiment of the present invention, the form in which the division members of the optical fiber holder 130 are positioned between the reflection surfaces 122 is shown. In this case, the shape formed by each division member of the optical fiber holder 130 may be particularly determined depending on the shape of the separation space of the reflection surface 122.

FIG. 1 and FIG. 2 show the shape of four reflection surfaces 122, wherein the division member of the optical fiber holder 130 has the quadrangle cross-section depending on the shape of the separation space formed between the reflection surfaces 122 and is formed at the separation space between the reflection surfaces 122.

As above-described, when the optical fiber holder 130 to fix the optical fiber 140 is provided on the same substrate 150 as the light source unit 110 and the reflection unit 120, even though spatial restrictions are likely to occur, according to an exemplary embodiment of the present invention, despite having an optical fiber holder 130, it has an advantage in space utilization.

If it is described with reference to the center part 124 of the reflection unit 120, the diameter of the optical fiber holder 130 may be the same as the diameter of the reflection unit 120, and thus, although the optical fiber holder 130 is provided, the increasing of the area occupied by the reflection unit 120 and the optical fiber holder 130 is minimized and hence it is possible to minimize the distance between the light source unit 110 and the reflection unit 120, so it is advantageous in implementing the exact focus of the optical signal.

On the other hand, FIG. 8 shows an exemplary embodiment in which six reflection surfaces 122 are formed, and in the case where a plurality of reflection surfaces 122 are provided, the division member of the optical fiber holder 130 may have a triangular or fan-shaped cross-sectional shape to correspond to each separation space shape between the reflection surfaces 122.

As a result, in an exemplary embodiment of the present invention, as the division member of the optical fiber holder 130 is positioned at the separation space between the reflection surfaces 122, the volume occupied by the reflection unit 120 and the optical fiber holder 130 may be minimized on the same plane, so it is advantageous in efficiently implementing the space aggregation of each configuration and in implementing an optimum design considering the accuracy of the optical signal.

On the other hand, as show in FIGS. 9 and 10, in the optical combiner according to an exemplary embodiment of the present invention, the plurality of division members configuring the optical fiber holder 130 may be disposed to enclose the circumference of the reflection unit 120.

In an exemplary embodiment among various exemplary embodiments of the present invention, the division member of the optical fiber holder 130 may be provided with the shape enclosing the circumference of the reflection unit 120, thereby supporting and fixing the optical fiber 140.

In this case, because the reflection unit 120 may be provided so that the separation space between the reflection surfaces 122 does not exist, the area capable of reflecting the optical signal increases such that a fluid design is possible in forming a structure capable of reflecting light.

Furthermore, as the diameter of the optical fiber 140 fixed by the optical fiber holder 130 may further increase, the permissible range of the value F may extend and the fluid range of the design is effectively improved.

FIG. 9 shows the division member of the optical fiber holder 130 provided to enclose the reflection unit 120. In this case, the optical fiber 140 having the larger diameter than the diameter of the reflection unit 120 may be fixed. In this case, the cross-sectional shape of each division member may be variously determined, and particularly may be determined depending on the number of light source units 110.

In the exemplary embodiment shown in FIG. 9, the division member is particularly prepared in the shape enclosing a corner side at which a plurality of reflection surfaces 122 of the reflection unit 120 are mutually in contact, thereby forming the stable structure in fixing the optical fiber 140.

Also, FIG. 10 (b) provides the various shapes of the reflection unit 120 in the exemplary embodiment shown in FIG. 9. As a matter of course, the shape of the reflection unit 120 can be variously determined as necessary.

On the other hand, as shown in FIG. 1 to FIG. 3, in the optical combiner according to an exemplary embodiment of the present invention, the plurality of division members are shaped so that the part toward the center part 124 of the reflection unit 120 is stepped, thereby forming the seating part 132 to which the optical fiber 140 is seated.

In detail, each division member of the optical fiber holder 130 in an exemplary embodiment of the present invention may be provided so that the part toward the center part 124 of the reflection unit 120 is in contact with the optical fiber 140. Accordingly, the plurality of division members may together support and fix one optical fiber 140.

In the division member, the seating part 132 of the stepped shape may be provided upward to seat the optical fiber 140 at the part toward the center part 124, and the optical fiber 140 is seated at the seating part 132 of the division member to be supported and fixed by the plurality of division members.

In this case, as the number of the division members increases, a force applied to each of the division members configuring the optical fiber holder 130 is dispersed, and accordingly, it is advantageous to stably fix the optical fiber 140. The stepped shape of the seating part 132 may be variously determined, and preferably, may be determined depending on the number of the division members and the cross-sectional shape of the optical fiber 140.

FIG. 1 shows a plurality of division members forming the length at the upper side of the reflection unit 120, and shows a shape with which the lower-stepped seating part 132 is formed at the part toward the center part 124 of the reflection unit 120 among the upper part in the plurality of division members.

The shape with which the optical fiber 140 is fixed at the seating part 132 formed in the plurality of division members shown in FIG. 1 is shown in FIG. 2. Referring to FIG. 2, according to the preferred exemplary embodiment of the present invention, it may be confirmed that the plurality of optical signals emitted from the plurality of light source units 110 radially disposed are focused at the upper side of the center part 124 of the reflection unit 120 by the reflection surface 122, and the optical fiber 140 is seated at the seating part 132 formed at the plurality of division members.

Particularly, as the seating part 132 is formed, the plurality of division members configuring the optical fiber holder 130 are positioned to enclose the lower side surface of the optical fiber 140, thereby enhancing the supporting and fixing force of the optical fiber 140.

Referring to FIG. 3, the cross-sectional shape of the seating part 132 formed on the division member of the optical fiber holder 130 from the side may be confirmed, and the shape with which the side surface of the optical fiber 140 is supported and fixed by the seating part 132 is shown.

On the other hand, as shown in FIG. 1, FIG. 2, FIG. 8, and FIG. 9, in the optical combiner according to an exemplary embodiment of the present invention, the light source unit 110 may emit the optical signal to the separation space between the plurality of division members.

In detail, in the preferred exemplary embodiment of the present invention, the plurality of light source units 110, the reflection surface 122, and the division member of the optical fiber holder 130 are disposed to be radial with respect to the center part 124 of the reflection unit 120.

However, because the optical signal emitted from the light source unit 110 must be positioned to directly face the reflection surface 122 to reflect the optical signal by the reflection surface 122, in the preferred exemplary embodiment of the present invention, the light source unit 110 is provided to emit the optical signal between the division members of the optical fiber holder 130.

That is, the light source unit 110 and the reflection surface 122 are disposed so as to face each other, and in this case, by providing the division member of the optical fiber holder 130 so as to be positioned except between the light source unit 110 and the reflection surface 122, the optical signal emitted from the light source unit 110 completely reaches the reflection surface 122. Referring to FIG. 1, FIG. 2, FIG. 8, and FIG. 9, it may be confirmed that the division member is positioned between the paths of the optical signal while the light source unit 110 and the reflection surface 122 are provided so as to face each other.

On the other hand, as shown in FIG. 14, the optical combiner according to an exemplary embodiment of the present invention may further include a substrate 150 supporting the optical fiber holder 130, the light source unit 110, and the reflection unit 120.

In detail, in an exemplary embodiment of the present invention, the optical fiber holder 130 may be provided together on the substrate 150 including the light source unit 110 and the reflection unit 120. As a result, the constituent elements constituting the optical combiner may be provided on the single substrate 150, thereby being advantageous for the packaging.

Also, according to the preferred exemplary embodiment of the present invention, because it is possible to minimize the required area by providing the optical fiber holder 130, it is advantageous to provide the optical fiber holder 130, the light source unit 110, and the reflection unit 120 together on the single substrate 150.

As a result, as an exemplary embodiment of the present invention provides one substrate 150 and provides the light source unit 110, the reflection unit 120, and the optical fiber holder 130 together on the substrate 150, it is advantageous in implementing the compact packaging design. FIG. 14 shows the substrate 150 on which the light source unit 110, the reflection unit 120, and the optical fiber holder 130 are provided together.

On the other hand, as shown in FIG. 14, the optical combiner according to an exemplary embodiment of the present invention further includes a focusing lens 180 disposed on the path of the optical signal between the reflection unit 120 and the light source unit 110 and a lens holder 185 at which the focusing lens 180 is seated, and the lens holder 185 may be supported on the substrate 150 along with the optical fiber holder 130, the light source unit 110, and the reflection unit 120.

In the preferred exemplary embodiment of the present invention, the focusing lens 180 may be provided between the reflection unit 120 and the light source unit 110, and preferably, a plurality of focusing lenses 180 may be provided and may be disposed to correspond to the plurality of light source units 110. Accordingly, when the light source units 110 are radially disposed according to the preferred exemplary embodiment of the present invention, the focusing lenses 180 may also be disposed to be radial.

As the focusing lens 180 is positioned on the path of the optical signal emitted from the light source unit 110, a level at which the optical signal emitted from the light source unit 110 is focused at the core of the optical fiber 140 through the reflection unit 120 is improved. Here, the focus of the optical signal by the focusing lens does not mean that the plurality of optical signals reflected by the reflection unit 120 are focused to the optical fiber 140, but means that most of the optical signal energy is focused to the core of the optical fiber 140 by suppressing or preventing a spread phenomenon of the optical signal emitted from the single light source unit 110.

That is, the focusing lens 180 plays a role of focusing one of the optical signals, and the focus level improvement of each of the plurality of optical signals by the focusing lens 180 is advantageous for finally improving the coupling efficiency of the multi-channel optical signal for the optical fiber 140.

On the other hand, the lens holding 185 may be provided to seat the focusing lens 180 in an exemplary embodiment of the present invention. The lens holder 185 may be prepared in various shapes, and may preferably have a structure in which the focusing lens 180 is seated on the top.

Also, the lens holder 185 may be prepared on the single substrate 150 along with the reflection unit 120, the light source unit 110, and the optical fiber holder 130, and a plurality of lens holders 185 are provided to correspond to the focusing lenses 180 to support and fix each focusing lens 180. On the other hand, the lens holder 185 may be provided as a single unit enclosing the periphery of the reflection unit 120, but it is also possible to provide a plurality of fixing portions to which each of the plurality of focusing lenses 180 is fixed.

As a result, in an exemplary embodiment of the present invention, the coupling efficiency between the optical signal and the optical fiber 140 may be effectively improved through the focusing lens 180, and furthermore, as the lens holder 185 to which the focusing lens 180 is seated is provided on the single substrate 150 along with the reflection unit 120, it is advantageous for the packing structure of the optical combiner of the present invention.

On the other hand, as shown in FIG. 14, in the optical combiner according to an exemplary embodiment of the present invention, a power unit 160 and a driver IC 165 for the light source unit 110 are mounted on the substrate 150.

The light source unit 110 may be provided with the power unit 160 to emit the optical signal, and may be prepared with the driver IC 165 for controlling the current and the like supplied from the power unit 160 to be supplied to the light source unit 110.

In this case, as the present invention prepares the power unit 160 and the driver IC 165 together on the single substrate 150, it is advantageous to package the entire optical combiner on the single substrate 150. The power unit 160 may be prepared with various types and shapes, and preferably with a pad shape.

FIG. 14 shows the shape in which the power unit 160 and the driver IC 165 for the light source unit 110 are prepared on one substrate 150 together with the light source unit 110, the reflection unit 120, and the optical fiber holder 130.

On the other hand, as shown in FIG. 14, in the optical combiner according to an exemplary embodiment of the present invention, the optical fiber holder 130 or the lens holder 185 may include a fixing member 170 cured to enclose the optical fiber 140 or the focusing lens 180 at the part where the optical fiber 140 or the focusing lens 180 is fixed.

In detail, the seating part 132 at which the optical fiber 140 is seated may be formed at each division member of the optical fiber holder 130, and the optical fiber 140 is seated and fixed at the seating part 132. In this case, in the preferred exemplary embodiment of the present invention, the fixing member 170 that is provided and cured at the circumference of the optical fiber 140 seated at the seating part 132 and on the division member may be further included.

The fixing member 170 may be provided after the molding of the optical fiber holder 130 and the fixing of the optical fiber 140. In this case, the fixing member 170 may be prepared to be joined to the top of the optical fiber holder 130 as a prefabricated separate material, but preferably as a material having fluidity that may be provided on the optical fiber holder 130 to be hardened to strengthen the fixing force of the optical fiber 140.

This fixing member 170 may be provided as various materials, such as an epoxy, and preferably, it be hardened after being provided on the top of the optical fiber holder 130.

On the other hand, the fixing member 170 of the optical fiber holder 130 can be similarly applied to the lens holder 185. That is, in an exemplary embodiment of the present invention, in the state that the focusing lens 180 is supported and fixed at the lens holder 185, the fixing member 170 as an upper part of the lens holder 185 may be provided and hardened at the contact point with the focusing lens 180, thereby enhancing the fixing force of the focusing lens 180.

FIG. 14 schematically shows the fixing member 170 provided on the division member of the optical fiber holder 130 and prepared to enclose the circumference of the optical fiber 140 and the fixing member 170 provided on the lens holder 185 and hardened to enclose the circumference of the focusing lens 180.

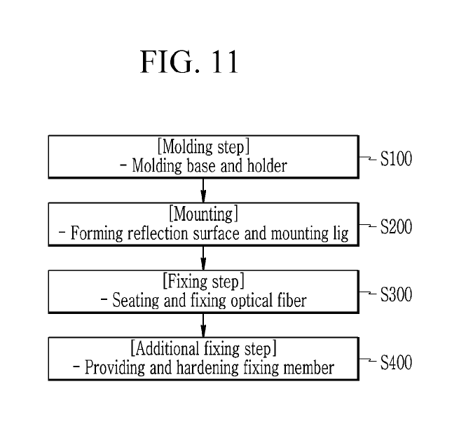

Further, as shown in FIG. 11 to FIG. 14, a manufacturing method of the optical combiner according to an exemplary embodiment of the present invention includes: a molding step (S100) of press-molding a base configuring the reflection unit 120 and the optical fiber holder 130 fixing the optical fiber 140; a mounting step (S200) of preparing the reflection surface 122 at the base and mounting the light source unit 110 emitting the optical signal to face the reflection surface 122; and a fixing step (S300) of seating and fixing the optical fiber 140 at the optical fiber holder 130.

In detail, in the molding step (S100), the base configuring the reflection unit 120 and the optical fiber holder 130 fixing the optical fiber 140 are pressed and molded. At this time, the base of the reflection unit 120 and the optical fiber holder 130 may be formed of different materials or may be molded through different processes, respectively, and may preferably be prepared with the same material and molded together.

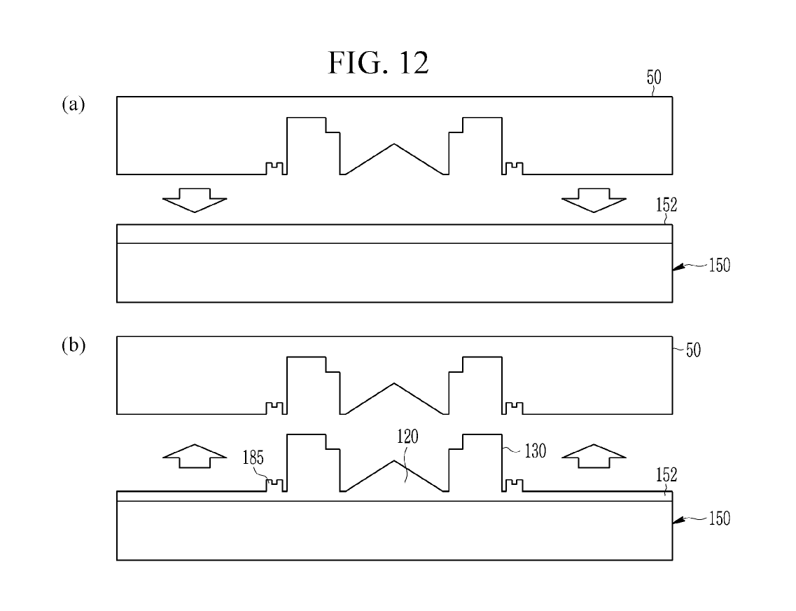

A shape of the base and the optical fiber holder 130 is carved with an engraving in a mold 50 for press-molding, and the base optical fiber holder 130 is molded by pressing a layer on the deformable substrate 150. Preferably, when the layer on the deformable substrate 150 is defined as a deformation layer 152, the substrate 150 may further include a supporting plate supporting the base and the optical fiber holder 130 after the press-molding as well as the deformation layer 152. FIG. 12 shows a process in which the base and the optical fiber holder 130 are molded together through the mold 50.

In the mounting step (S200), the reflection surface 122 is prepared at the base, and the light source unit 110 emitting the optical signal is mounted to face the reflection surface 122. In an exemplary embodiment of the present invention, the reflection surface 122 may be separately prepared at an outer surface of the base. The reflection surface 122 may be provided in the form of the inclined plate, and may be prepared with a metal having high reflectance for the optical signal and excellent conductivity. In addition to the formation of the reflection surface 122, the substrate 150 is mounted with the light source unit 110.

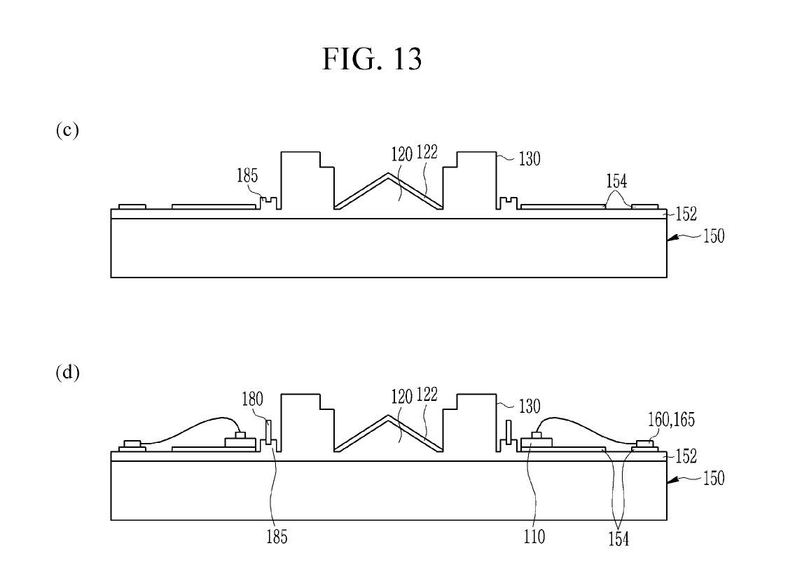

It is desirable that the light source unit 110 coupled to the substrate 150 is positioned in the same radius direction with reference to the center part 124 of the reflection unit 120 so as to face the reflection surface 122. FIG. 13 shows a process in which the reflection surface 122 and the light source unit 110 are mounted on the substrate 150.

On the other hand, in the fixing step (S300), the optical fiber 140 is settled and fixed to the optical fiber holder 130. The optical fiber holder 130 molded through the molding step (S100) is provided together on the same substrate 150 as the light source unit 110 and the base, and in this case, the optical fiber 140 provided at the optical fiber holder 130 is preferably positioned on the center part 124 of the reflection unit 120 by the optical fiber holder 130. FIG. 14 shows that the optical fiber 140 is seated between each division member of the optical fiber holder 130 provided on the substrate 150.

As a result, an exemplary embodiment of the present invention is advantageous to prepare the light source unit 110, the reflection unit 120, and the optical fiber holder 130 together on the single substrate 150, and particularly to manufacture the optical combiner with improved accuracy through the manufacturing and the packaging structure of the mold 50 by considering the predetermined design characteristics.

On the other hand, as shown in FIG. 12, in the manufacturing method of the optical combiner according to an exemplary embodiment of the present invention, the molding step S100 molds the base and the optical fiber holder 130 on the substrate 150 by pressing the deformation layer 152 coated on at least one surface of the substrate 150.

As above-described, because the substrate 150 pressed by the present invention must have the structure in which the base and the optical fiber holder 130 are molded and simultaneously the molded base and optical fiber holder 130 are seated, the substrate 150 proposed in the present invention is prepared with the deformation layer 152 that may be easily moldable on at least one surface by the pressing process.

The deformation layer 152 may be prepared of various materials, and particularly the deformation layer 152 must have better moldability than a supporting plate that is distinguished from the deformation layer 152 and fixes and supports the base and the optical fiber holder 130.

Referring to FIG. 12, as the substrate 150 coated with the deformation layer 152 is provided, and the mold 50 engraved with the base and the optical fiber holder 130 presses the deformation layer 152 to be molded, the shape in which the base and the optical fiber holder 130 are formed on the substrate 150 is shown.

On the other hand, as shown in FIG. 13, in the manufacturing method of the optical combiner according to an exemplary embodiment of the present invention, the mounting step (S200) may form the reflection surface 122 at the part of the deformation layer 152, or may provide a metal coating part 154 to mount the light source unit 110 as a metal having excellent conductivity, and mount the light source unit 110 at the metal coating part 154.

The metal coating part 154 may be provided through a screening or mask forming process for the deforming side surface. In an exemplary embodiment of the present invention, the metal coating part 154 may be provided on the outer surface of the base so that the metal coating part 154 forms the reflection surface 122.

Further, the metal coating part 154 provided on the substrate 150 other than the base may be a part to which a member prepared by a method other than the press molding is mounted. For example, the light source unit 110 is not directly mounted to the deformation layer 152, but may be mounted to the metal coating part 154 after forming the metal coating part 154, thereby improving the stability for the coupling.

On the other hand, as shown in FIG. 13, in the manufacturing method of the optical combiner according to an exemplary embodiment of the present invention, the mounting step (S200) may further mount the power unit 160 and the driver IC 165 of the light source unit 110 to the substrate 150.

Like a manufacturing process of a semiconductor, an exemplary embodiment of the present invention may mount the power unit 160 and the driver IC 165 on the substrate 150 provided with the reflection unit 120 and the optical fiber holder 130 as well as the light source unit 110. The substrate 150 on which the power unit 160 and driver IC 165 are mounted is itself an optical combiner package, and accordingly the optical combiner may be easily and effectively packaged, thereby increasing production efficiency.

The power unit 160 may be provided with the pad shape, and the power unit 160 and the driver IC 165 may be mounted to the metal coating part 154 like the light source unit 110. FIG. 13 schematically shows a process in which the driver IC 165 and the power unit 160 are provided along with the light source unit 110.

On the other hand, as shown in FIG. 12 and FIG. 13, in the manufacturing method of the optical combiner according to an exemplary embodiment of the present invention, in the molding step (S100), the lens holder 185 to mount the focusing lens 180 may be pressed along with the base and the optical fiber holder 130 to be molded, and in the mounting step (S200), the focusing lens 180 may be mounted to the lens holder 185.

In an exemplary embodiment of the present invention, the focusing lens 180 may be prepared to increase the coupling efficiency of the optical signal. In the molding step (S100) according to an exemplary embodiment of the present invention, the lens holder 185 to seat the focusing lens 180 may be press-molded to be prepared on the single substrate 150 along with the base and the optical fiber holder 130. FIG. 12 shows the lens holder 185 molded on the single substrate 150 as described above.

Also, FIG. 13 shows the focusing lens 180 mounted to the lens holder 185 according to the mounting step (S200) supporting and fixing the focusing lens 180 to the lens holder 185 after the molding step (S100).

On the other hand, as shown in FIG. 14, in the manufacturing method of the optical combiner according to an exemplary embodiment of the present invention, after the fixing step (S300), an additional fixing step (S400) for providing and hardening the fixing member 170 to fix the optical fiber 140 or the focusing lens 180 at the part where the optical fiber 140 or the focusing lens 180 are seated and fixed in the optical fiber holder 130 or the lens holder 185 may be further included.

As above-described, the fixing member 170 is preferably provided at the part where the optical fiber 140 is seated and fixed as the upper side of the optical fiber holder 130. The fixing member 170 is provided to be easily deformed when being provided to the optical fiber holder 130, and is hardened while wrapping the optical fiber 140, thereby forming the structure fixing the optical fiber 140. The fixing member 170 may be made of various materials, but it is preferably provided as a material like the epoxy that may be cured with the moldability under certain conditions.

Referring to FIG. 14, a process in which the optical fiber 140 is seated and fixed on each division member of the optical fiber holder 130 prepared through the press molding, and the fixing member 170 is provided and hardened at the seated and fixed part of the optical fiber 140, is schematically shown.

On the other hand, the above process can be similarly applied to the lens holder 185. That is, as the fixing member 170 is provided and hardened at the part where the focusing lens 180 is mounted in the lens holder 185, the fixing force for the focusing lens 180 may be enhanced. FIG. 14 shows the shape in which the fixing member 170 is prepared at the upper part side of the lens holder 185 along with the optical fiber holder 130.

Although the present invention has been shown and described with reference to specific embodiments, it is obvious to those skilled in the art that the present invention may be variously modified and changed within limits not departing from the technical spirit of the present invention as provided by the following claims.

### DESCRIPTION OF SYMBOLS

| | | | |
|---|---|---|---|
| 110: | light source unit | 120: | reflection unit |
| 122: | reflection surface | 124: | center part |
| 130: | optical fiber holder | 132: | seating part |
| 140: | optical fiber | 150: | substrate |
| 152: | deformation layer | 50: | mold |
| 154: | metal coating part | 160: | power unit |
| 165: | driver IC | 170: | fixing member |
| 180: | focusing lens | 185: | lens holder |
| S100: | molding step | S200: | mounting step |
| S300: | fixing step | S400: | additional fixing step |

What is claimed is:

1. An optical combiner comprising:
a plurality of light source units emitting an optical signal;
a reflection unit having a plurality of reflection surfaces disposed on a path of the optical signal and reflecting the optical signal so as to face toward an optical fiber; and
an optical fiber holder fixing the optical fiber at a position where the optical signal reflected by the plurality of reflection surfaces is focused,
wherein the optical fiber holder includes a plurality of division members radially disposed with respect to a center part of the reflection unit.

2. The optical combiner of claim 1, wherein
the plurality of light source units are radially disposed with respect to the reflection unit.

3. The optical combiner of claim 2, wherein
the plurality of reflection surfaces correspond to the plurality of light source units and at least parts thereof are radially disposed to be mutually separated.

4. The optical combiner of claim 1, wherein
the reflection surface is provided as an inclined plate to reflect the optical signal emitted from the light source unit to an upper side of the center part of the reflection unit, and the optical fiber holder fixes the optical fiber at the upper side of the center part of the reflection unit.

5. The optical combiner of claim 4, wherein
the reflection surface is configured so that a horizontal distance of one end toward the light source unit and the other end toward the center part of the reflection unit is longer than a mutual vertical height.

6. The optical combiner of claim 1, wherein
the plurality of reflection surfaces have at least parts separated from each other and positioned between the center part of the reflection unit and the plurality of light source units, and
the plurality of division members are respectively positioned at each separation space between the plurality of reflection surfaces.

7. The optical combiner of claim 1, wherein
the plurality of division members configuring the optical fiber holder are disposed to enclose a circumference of the reflection unit.

8. The optical combiner of claim 1, wherein
each of the plurality of division members comprises a part toward the center part of the reflection unit at a top thereof, the part is stepped such that a seating part to which the optical fiber is seated is formed.

9. The optical combiner of claim 1, wherein
the light source unit emits the optical signal to separated spaces between the plurality of division members.

10. The optical combiner of claim 1, further comprising
a substrate supporting the optical fiber holder, the light source unit, and the reflection unit.

11. The optical combiner of claim 10, further comprising
a focusing lens disposed on a path of the optical signal between the reflection unit and the light source unit and a lens holder to which the focusing lens is seated, wherein the lens holder is supported to the substrate along with the optical fiber holder, the light source unit, and the reflection unit.

12. The optical combiner of claim 11, wherein
a power unit and a driver IC for the light source unit are mounted on the substrate.

13. The optical combiner of claim 1, wherein
the optical fiber holder or the lens holder includes a fixing member that is hardened to enclose the optical fiber or the focusing lens at a part where the optical fiber or the focusing lens is fixed.

14. A manufacturing method of an optical combiner, comprising:
press-molding an optical fiber holder fixing an optical fiber and a base configuring a reflection unit;
preparing a reflection surface at the base and mounting a light source unit emitting an optical signal to face the reflection surface; and
seating and fixing the optical fiber to the optical fiber holder.

15. The manufacturing method of claim 14, wherein
in the molding, a deformation layer coated on at least one surface of the substrate is press-molded to mold the base and the optical fiber holder to the substrate.

16. The manufacturing method of claim 15, wherein
in the mounting, the reflection surface is formed at a part of the deformation layer, or a metal coating part to which the light source unit is mounted may be provided, and the light source unit is mounted to the metal coating part.

17. The manufacturing method of claim 16, wherein
a power unit and a driver IC of the light source unit are further mounted to the substrate in the mounting.

18. The manufacturing method of claim 14, wherein
a lens holder to which the focusing lens is seated is press-molded along with the base and the optical fiber holder in the molding, and
the focusing lens is mounted to the lens holder in the mounting.

19. The manufacturing method of claim 18, further comprising
providing and hardening a fixing member to fix the optical fiber or the lens holder at a part where the optical fiber or the focusing lens is seated and fixed in the optical fiber holder or the lens holder, after the fixing.
